(19) United States
(12) Patent Application Publication
(10) Pub. No.: US 2024/0031429 A1
(43) Pub. Date: Jan. 25, 2024

(54) METHOD FOR PROCESSING DATA IN B2B CLOUD DISTRIBUTION PLATFORM SYSTEM

(71) Applicant: HAINAN CLOUD INFORMATION TECHNOLOGY CO., LTD., Haikou City (CN)

(72) Inventors: Feng Wu, Haikou City (CN); Chaoju Qin, Haikou City (CN)

(21) Appl. No.: 17/297,250

(22) PCT Filed: May 17, 2021
(86) PCT No.: PCT/CN2021/094008

§ 371 Date: Oct. 20, 2022

(30) Foreign Application Priority Data
Apr. 13, 2021 (CN) 202110395816.9

(51) Int. Cl. H04L 67/1008; H04L 67/1029

(52) U.S. Cl. CPC H04L 67/1008; H04L 67/1029

(57) ABSTRACT

A method for processing data in a B2B cloud distribution platform system, which includes dividing server nodes into primary cluster, secondary cluster and idle cluster pool; obtain the average resource utilization of multiple server nodes in the primary and secondary clusters on a regular basis. If the average resource utilization of the server nodes in the primary cluster is greater than or equal to the minimum threshold, the server nodes in the idle cluster pool are migrated to the primary cluster. If the average resource utilization of the server nodes in the secondary cluster is less than the minimum threshold, the server nodes in the secondary cluster are moved out to the idle cluster pool. If it is between the lowest and highest thresholds, it will not migrate. If it is greater than or equal to the maximum threshold, the server nodes in the idle cluster pool are migrated to the secondary cluster. Based on the problem that the existing cloud distribution platform system has a large amount of data processing and a high requirement for server resources. The present invention puts forward a load balancing method, which can make the best use of server resources and improve the data processing efficiency of the platform system.

### FIELD OF THE INVENTION

The present invention relates to the field of data processing technology, in particular to a method for processing data in a B2B cloud distribution platform system.

### BACKGROUND OF THE INVENTION

The popularization of information technology has promoted the emergence of more and more cloud distribution platform systems, especially for the tourism industry, most of the tourism operators have adopted the combination of online and offline. Users can order online before accepting offline services.

However, the characteristics of the tourism industry bring many challenges to the cloud distribution platform system:
1. The tourism industry has distinct characteristics of the off-peak season. The processing reserve of the server needs to be adjusted differently according to the needs of the off-peak season. Otherwise, the off-season equipment cannot be fully utilized and resources are wasted. In peak season, the device cannot meet the corresponding demand, which affects the user experience.
2. When users order front-end products, the backend product server is overloaded, resulting in data carton or data loss.

Therefore, it is necessary to provide a data processing method to give the cloud distribution platform a complete load scheme.

### SUMMARY OF THE INVENTION

In order to solve the shortcomings of the existing technology, The present invention provides a data processing method of a B2B cloud distribution platform system, which comprises the following steps:
Step S1: divide all server nodes into primary cluster, secondary cluster and idle cluster pool, there are multiple server nodes in the primary cluster, secondary cluster and idle cluster pool, the server nodes in the primary cluster are used to handle core business, and the server nodes in the secondary cluster are used to handle basic data business with low real-time requirements and large processing capacity, the idle cluster pool is used to accommodate idle server nodes;
Step S2: cloud distribution platform system periodically obtains the average resource utilization of multiple server nodes in the primary cluster and the secondary cluster by polling;
Step S3: if the average resource utilization of the server nodes in the primary cluster is greater than or equal to the minimum threshold, the server nodes in the idle cluster pool will be migrated to the primary cluster until the average resource utilization of the server nodes in the primary cluster is less than the minimum threshold, and then skip to Step S4; if the average resource utilization of the server nodes in the primary cluster is less than the minimum threshold, it jumps directly to Step S4;
Step S4: if the average resource utilization of the server nodes in the secondary cluster, the server nodes with the highest resource utilization in the primary cluster will be moved out of the idle cluster pool in order from large to small until the average resource utilization of the server nodes in the primary cluster is greater than or equal to the minimum threshold; if the average resource utilization of server nodes in the secondary cluster is between the minimum and maximum thresholds, no migration occurs, if the average resource utilization of the server nodes in the primary cluster is greater than or equal to the maximum threshold, the server nodes in the idle cluster pool are migrated to the secondary cluster until the average resource utilization of the server nodes in the secondary cluster is less than the maximum threshold.

In step S3, if the average resource utilization of the server nodes in the primary cluster is greater than or equal to the minimum threshold, after migrating the server nodes in the idle cluster pool to the primary cluster, migrate the service directories in the original server nodes of the primary cluster to the incoming server nodes, in the order of resource utilization from large to small, prioritize migrating service directories in the server nodes with the highest resource utilization.

In step S3, when migrating a service directory, determine if the size of the service directory you want to migrate is greater than the directory threshold. If the directory threshold is greater than the directory threshold, the migration directory is broken up into several sub-service directories that are less than or equal to the directory threshold, and the migration of the sub-service directories is completed in turn.

In Step S4, if the average resource utilization of the server nodes in the secondary cluster is less than the minimum threshold, after the server nodes in the secondary cluster have been moved out, the directory of services on the moved server nodes will be moved into the remaining server nodes in the secondary cluster, and the server nodes with the least resource utilization will be moved in priority from small to large;

If the average resource utilization of the server nodes in the secondary cluster is greater than or equal to the maximum threshold, then after migrating the server nodes in the idle cluster pool to the secondary cluster, the service directories in the original server nodes of the secondary cluster are migrated to the incoming server nodes in the order of resource utilization from large to small, prioritize migrating service directories in the server nodes with the highest resource utilization.

In Step S4, when migrating a service directory, determine if the size of the service directory you want to migrate is greater than the directory threshold, if the directory threshold is greater than the directory threshold, the migration directory is broken up into several sub-service directories that are less than or equal to the directory threshold, and the migration of the sub-service directories is completed in turn.

The average resource utilization is calculated by averaging the resource utilization of all server nodes in the primary or secondary cluster, the resource utilization of each server node is obtained by weighted average of CPU utilization, memory utilization, network send and receive rate utilization.

In Step S3, if the average resource utilization of the server nodes in the primary cluster is greater than or equal to the minimum threshold, after migrating the server nodes in the idle cluster pool to the primary cluster, load balancing of the server nodes in the primary cluster is achieved by following steps:
Step S31: obtain the static and dynamic load parameters of each server node, and weighted average the comprehensive load parameters:
Step S32: the average comprehensive load parameters of the main cluster are obtained by averaging the comprehensive load parameters of all the server nodes. The server nodes whose comprehensive load parameters are lower than the average comprehensive load parameters are the target server nodes, and the server nodes whose comprehensive load parameters are higher than the average comprehensive load parameters are the source server nodes;
Step S33: source server nodes are arranged in the order of comprehensive load parameters from large to small, and target server nodes are arranged in the order of comprehensive load parameters from small to large, so that source server nodes and target server nodes correspond in the corresponding order;
Step S34: in order from large to small, the service directory in the source server node with the largest comprehensive load parameter is migrated first to the target server node with the smallest comprehensive load parameter until all server nodes achieve load balancing.

In Step S34, when migrating a service directory, determine if the size of the service directory you want to migrate is greater than the directory threshold. If the directory threshold is greater than the directory threshold, the migration directory is broken up into several sub-service directories that are less than or equal to the directory threshold, and the migration of the sub-service directories is completed in turn.

In Step S4, if the average resource utilization of the server nodes in the secondary cluster is greater than or equal to the maximum threshold, the server nodes in the idle cluster pool are migrated to the secondary cluster, or, if the average utilization of server nodes in secondary cluster is less than the minimum threshold, load balancing of server nodes in secondary cluster is achieved by migrating the server nodes in the secondary cluster to the idle cluster pool and migrating the service directories on the migrated server nodes back to the secondary cluster by following steps:
Step S41: obtain the static and dynamic load parameters of each server node, and weighted average the comprehensive load parameters,
Step S42: the average comprehensive load parameters of the secondary cluster are obtained by averaging the comprehensive load parameters of all the server nodes, the server nodes whose comprehensive load parameters are lower than the average comprehensive load parameters are the target server nodes, and the server nodes whose comprehensive load parameters are higher than the average comprehensive load parameters are the source server nodes;
Step S43: source server nodes are arranged in the order of comprehensive load parameters from large to small, and target server nodes are arranged in the order of comprehensive load parameters from small to large, so that source server nodes and target server nodes correspond in the corresponding order;
Step S44: in order from large to small, the service directory in the source server node with the largest comprehensive load parameter is migrated first to the target server node with the smallest comprehensive load parameter until all server nodes achieve load balancing.

In Step S44, when migrating a service directory, determine if the size of the service directory you want to migrate is greater than the directory threshold. If the directory threshold is greater than the directory threshold, the migration directory is broken up into several sub-service directories that are less than or equal to the directory threshold, and the migration of the sub-service directories is completed in turn.

The data processing method of the B2B cloud distribution platform system provided by the invention is based on the problems that the existing cloud distribution platform system has large data processing capacity and high requirements for server resources, and proposes a method based on load balancing, which can make the best use of server resources and improve the data processing efficiency of the platform system.

### DETAILED DESCRIPTION OF EXEMPLARY EMBODIMENTS

In order to have a further understanding of the technical scheme and beneficial effects of the invention, the technical scheme of the invention and its beneficial effects are described in detail below.

The data processing method of the B2B cloud distribution platform system provided by the invention is based on the problems that the existing cloud distribution platform system has large data processing capacity and high requirements for server resources, and proposes a method based on load balancing, so as to make the best use of the server resources and improve the data processing efficiency of the platform system.

### I. Server Node Allocation Principle

When processing business data, any distribution platform system has different priorities. Some businesses are related to the core business and need the server to have sufficient resource space and processing efficiency to ensure that the core business can be processed timely and effectively, while others are related to the processing of basic service data, with large processing capacity but low real-time requirements, These services have relatively low requirements for servers. Therefore, based on this feature, the invention divides all server nodes under the platform system into three clusters: primary cluster, in which the server nodes are used to process the core business; Secondary cluster, in which the server nodes are used to process the basic business; Idle cluster pool is used to accommodate idle server nodes to meet the demand of platform system in off-season and peak season. In off-season, the Secondary cluster migrates some server nodes to the idle cluster pool to save the consumption of server nodes and improve the service life of the whole equipment. In peak season, the idle cluster pool migrates some server nodes to the Secondary cluster, To ensure the efficiency of the whole equipment.

In the actual use stage, the minimum and maximum thresholds corresponding to the resource utilization rate of the server nodes can be set in advance according to the actual performance of the equipment and the work needs of the platform system. Because the business handled by the primary cluster is more important, the average resource utilization rate of the server nodes in the primary cluster needs to meet the needs of being less than the minimum threshold, that is, When the average resource utilization of the server nodes in the primary cluster is greater than or equal to the minimum threshold, the server nodes in the idle cluster pool will be migrated to the primary cluster until the average resource utilization of the server nodes in the primary cluster is less than the minimum threshold, and the server nodes in the primary cluster will not migrate out in any case.

Correspondingly, because the services handled by the secondary cluster are relatively minor, the average resource utilization rate of the server nodes in the secondary cluster does not need to meet the requirement of constant less than the minimum threshold: if the average resource utilization rate of the server nodes in the secondary cluster is less than the minimum threshold, the server nodes with high resource utilization rate in the secondary cluster will be moved out of the idle cluster pool in order from large to small, Until the average resource utilization of the server nodes in the secondary cluster is greater than or equal to the minimum threshold; If the average resource utilization of the server nodes in the secondary cluster is between the lowest and the highest threshold, it will not be migrated; if the average resource utilization of the server nodes in the secondary cluster is greater than or equal to the maximum threshold, the server nodes in the idle cluster pool are migrated to the secondary cluster until the average resource utilization of the server nodes in the secondary cluster is less than the maximum threshold

In addition, when balancing the load of the server nodes in the whole platform system, priority should be given to meet the business needs of the primary cluster, that is, after the primary cluster realizes the migration needs of the server nodes, the resource utilization of the secondary cluster can be determined.

To sum up, by setting the primary cluster, secondary cluster and idle cluster pool, and based on the setting of the minimum threshold and the maximum threshold, the invention can give different migration schemes to the primary cluster and secondary cluster, so that the invention can allocate resources according to different business needs, and can meet the actual needs of the low and peak seasons.

In the invention, the average resource utilization rate is obtained by taking the average value of resource utilization rate of all server nodes in the primary cluster or secondary cluster, and the resource utilization rate of each server node is obtained by taking the weighted average value of CPU utilization rate, memory utilization rate and network transceiver rate utilization rate.

### II. Load Balancing Method

### 1. Migration of Idle Cluster Pool to Primary Cluster or Secondary Cluster

When the average resource utilization of the server nodes in the primary cluster is greater than or equal to the minimum threshold, or the average resource utilization of the server nodes in the secondary cluster is greater than or equal to the maximum threshold, the server nodes in the idle cluster pool need to be migrated to the primary cluster or the secondary cluster, It is necessary to migrate the files on the original server nodes in the primary cluster or the secondary cluster to the incoming server nodes, or to migrate the files on the server nodes with higher resource utilization in the primary cluster or the secondary cluster to the server nodes with lower resource utilization, so as to realize the load balancing of the server nodes in each cluster; For the convenience of description, the server nodes that move out of the service directory are collectively referred to as the source server node, also known as the move out node, and the server nodes that move into the service directory are collectively referred to as the target server node, also known as the move in node; In the specific implementation, by comparing the average resource utilization rate in the current cluster with the resource utilization rate of each server node, the emigration node or the emigration node can be determined; the server node whose resource utilization rate is greater than the average resource utilization rate is the emigration node, and the server node whose resource utilization rate is less than the average resource utilization rate is the emigration node.

In load balancing of load server node resources, the invention provides two detailed load balancing schemes as follows:

### Scheme I:

All outgoing nodes are ordered from the largest to the smallest resource utilization, and those with the most resource utilization are given priority. The difference between resource utilization and average resource utilization determines the size of the outgoing service directory. All the inbound nodes are sorted in order of resource utilization from small to large, and those with low resource utilization are preferentially moved in. The difference between average resource utilization and resource utilization determines the size of the inbound service directory.

Migrate the service directory from the outgoing node(Node 1 for short) with the highest resource utilization to the inbound node(Node 2 for short) with the lowest resource utilization until the outgoing node has the average resource utilization standard. If Node 2 can take over all the service directories that Node 1 has moved out and has free space. The next step is to move the service directory from the outgoing node(Node 3 for short) with the second highest resource utilization to the Node 2 until the Node 2 reaches the average resource utilization, and then to the inbound node(Node 4 for short) with the second lowest resource utilization. If the Node 2 cannot take over all the service directories that the Node 1 moved out of, after the Node 2 achieves the average resource utilization, migrate the remaining service directories of the Node 1 to the Node 4, and so on, until all server nodes in each cluster have completed load balancing.

### Scheme II:

After determining the average resource utilization rate, find out the outgoing nodes whose resource utilization rate is greater than the average resource utilization rate, and the inbound nodes whose resource utilization rate is less than the average resource utilization rate. It is important to note that the inbound nodes here do not include the new server nodes that are moved into the idle resource pool. The server nodes that are moved into the idle resource pool are referred to as the zero node. Because there is no service directory above; The service directories in each outgoing node are moved out to the zero node in turn until the average resource utilization rate of each outgoing node is reached. The service directory on each zero node is moved to each incoming node sequentially, so that the resource utilization of the incoming node and each zero node can reach the average resource utilization level.

### 2. Secondary Cluster Migration to Idle Cluster Pool.

With this migration, after the server node is moved out, the service directory on the server node needs to be moved back to the original secondary cluster.

A detailed load balancing approach is as follows: Referring to scenario 1 or scenario 2 above, the remaining server nodes in the secondary cluster are first load balanced, and then the service directories on the server nodes that have moved out of the secondary cluster are evenly distributed among the existing server nodes.

Or, in order from large to small, the corresponding resource utilization of server nodes that have moved out of the secondary cluster can be moved into the remaining server nodes of the secondary cluster in order from large to small. When moving in, the remaining server nodes of the secondary cluster receive the service directory in order from small to large resource utilization. That is, the outgoing server node with the highest resource utilization moves the service directory to the server node with the lowest remaining resource utilization in the secondary cluster, the outgoing server node with the highest resource utilization moves the service directory to the server node with the lowest remaining resource utilization in the secondary cluster, and so on. Until all the service directories in the moved out nodes are returned to the secondary cluster, load balancing of the entire secondary cluster is achieved according to scenario 1 or 2 above.

Since the service directory cannot be accessed by users during the migration process, and the corresponding functions on its programs cannot be implemented, the migration of the service directory will inevitably result in a system wait time. In order to reduce this time as much as possible and improve the user experience. The present invention sets a directory threshold value so that when migrating the service directory. Determine if the size of the service directory you want to migrate is greater than the directory threshold. If it is greater than the directory threshold, the migration directory will be broken into several sub-service directories that are less than or equal to the directory threshold, and the migration of the sub-service directories will be completed in turn. In this way, the size of service directory data is controlled for each migration, and the process waiting is controlled to reduce user wait time.

In addition, the resource utilization rate provided by the present invention only takes into account the static load parameters, so it is easy to obtain and calculate the static load parameters, and it is convenient to process when the server nodes between the primary cluster, the secondary cluster and the idle cluster pool share each other. However, after the migration of server nodes, only static load parameters can be considered to achieve preliminary cluster load balancing. In order to ensure more stable load balancing for each cluster, the present invention introduces the concept of dynamic load parameters.

That is, in the above scenarios 1 and 2, the comprehensive load parameters obtained after weighted averaging of static and dynamic load parameters can be used instead of resource utilization to achieve the final load balancing within each cluster.

In the present invention, dynamic load parameters are obtained by benchmarking the performance of each server node by setting the dynamic load parameter of the server node with the longest test time to 1, and the ratio of the test time of the remaining server nodes to the test time of the longest server node to its corresponding dynamic load parameters. This allows for changes in the processing power of the server nodes during their actual work.

The beneficial effects of the present invention are as follows:
1. By setting up the primary cluster and the secondary cluster, resources can be allocated according to different business needs, which can first meet the needs of core business and enhance the user experience.
2. By setting up an idle cluster pool, it can meet the needs of the system in low and high seasons.
3. By splitting the service directory into sub-service directory migration settings, the waiting time for user access during data migration can be reduced and the user experience can be improved.
4. Through the combination of average resource utilization and comprehensive load parameters, different load strategies can be given for load balancing among clusters and load balancing within clusters, which are both efficient and stable.

Although the present invention has been described with the above better examples, it is not intended to define the scope of protection of the present invention, and any person skilled in the field shall, without departing from the spirit and scope of the present invention, make various changes and modifications relative to the above implementation cases still fall within the scope of protection of the present invention, so the scope of protection of the present invention shall prevail as defined in the claims.

1. A method for processing data in a B2B cloud distribution platform system, comprising:
Step S1: divide all server nodes into primary cluster, secondary cluster and idle cluster pool, there are multiple server nodes in the primary cluster, secondary cluster and idle cluster pool, the server nodes in the primary cluster are used to handle core business, and the server nodes in the secondary cluster are used to handle basic data business with low real-time requirements and large processing capacity, the idle cluster pool is used to accommodate idle server nodes;
Step S2: cloud distribution platform system periodically obtains the average resource utilization of multiple server nodes in the primary cluster and the secondary cluster by polling;
Step S3: if the average resource utilization of the server nodes in the primary cluster is greater than or equal to the minimum threshold, the server nodes in the idle cluster pool will be migrated to the primary cluster until the average resource utilization of the server nodes in the primary cluster is less than the minimum threshold, and then skip to Step S4; if the average resource utilization of the server nodes in the primary cluster is less than the minimum threshold, it jumps directly to Step S4;
Step S4: if the average resource utilization of the server nodes in the secondary cluster, the server nodes with the highest resource utilization in the primary cluster will be moved out of the idle cluster pool in order from large to small until the average resource utilization of the server nodes in the primary cluster is greater than or equal to the minimum threshold; if the average resource utilization of server nodes in the secondary cluster is between the minimum and maximum thresholds, no migration occurs, if the average resource utilization of the server nodes in the primary cluster is greater than or equal to the maximum threshold, the server nodes in the idle cluster pool are migrated to the secondary cluster until the average resource utilization of the server nodes in the secondary cluster is less than the maximum threshold.

2. The method for processing data of claim 1, wherein step S3, if the average resource utilization of the server nodes in the primary cluster is greater than or equal to the minimum threshold, after migrating the server nodes in the idle cluster pool to the primary cluster, migrate the service directories in the original server nodes of the primary cluster to the incoming server nodes, in the order of resource utilization from large to small, prioritize migrating service directories in the server nodes with the highest resource utilization.

3. The method for processing data of claim 1, wherein step S3, when migrating a service directory, determine if the size of the service directory you want to migrate is greater than the directory threshold; if the directory threshold is greater than the directory threshold, the migration directory is broken up into several sub-service directories that are less than or equal to the directory threshold, and the migration of the sub-service directories is completed in turn.

4. The method for processing data of claim 1, wherein Step S4, if the average resource utilization of the server nodes in the secondary cluster is less than the minimum threshold, after the server nodes in the secondary cluster have been moved out, the directory of services on the moved server nodes will be moved into the remaining server nodes in the secondary cluster, and the server nodes with the least resource utilization will be moved in priority from small to large;
if the average resource utilization of the server nodes in the secondary cluster is greater than or equal to the maximum threshold, then after migrating the server nodes in the idle cluster pool to the secondary cluster, the service directories in the original server nodes of the secondary cluster are migrated to the incoming server nodes in the order of resource utilization from large to small, prioritize migrating service directories in the server nodes with the highest resource utilization.

5. The method for processing data of claim 1, wherein Step S4, when migrating a service directory, determine if the size of the service directory you want to migrate is greater than the directory threshold; if the directory threshold is greater than the directory threshold, the migration directory is broken up into several sub-service directories that are less than or equal to the directory threshold, and the migration of the sub-service directories is completed in turn.

6. The method for processing data of claim 1, wherein the average resource utilization is calculated by averaging the resource utilization of all server nodes in the primary or secondary cluster, the resource utilization of each server node is obtained by weighted average of CPU utilization, memory utilization, network send and receive rate utilization.

7. The method for processing data of claim 1, wherein Step S3, if the average resource utilization of the server nodes in the primary cluster is greater than or equal to the minimum threshold, after migrating the server nodes in the idle cluster pool to the primary cluster, load balancing of the server nodes in the primary cluster is achieved by following steps:
Step S31: obtain the static and dynamic load parameters of each server node, and weighted average the comprehensive load parameters;
Step S32: the average comprehensive load parameters of the main cluster are obtained by averaging the comprehensive load parameters of all the server nodes, the server nodes whose comprehensive load parameters are lower than the average comprehensive load parameters are the target server nodes, and the server nodes whose comprehensive load parameters are higher than the average comprehensive load parameters are the source server nodes;
Step S33: source server nodes are arranged in the order of comprehensive load parameters from large to small, and target server nodes are arranged in the order of comprehensive load parameters from small to large, so that source server nodes and target server nodes correspond in the corresponding order; and
Step S34: in order from large to small, the service directory in the source server node with the largest comprehensive load parameter is migrated first to the target server node with the smallest comprehensive load parameter until all server nodes achieve load balancing.

8. The method for processing data of claim 7, wherein Step S34, when migrating a service directory, determine if the size of the service directory you want to migrate is greater than the directory threshold; if the directory threshold is greater than the directory threshold, the migration directory is broken up into several sub-service directories that are less than or equal to the directory threshold, and the migration of the sub-service directories is completed in turn.

9. The method for processing data of claim 1, wherein Step S4, if the average resource utilization of the server nodes in the secondary cluster is greater than or equal to the maximum threshold, the server nodes in the idle cluster pool are migrated to the secondary cluster, or, if the average utilization of server nodes in secondary cluster is less than the minimum threshold, load balancing of server nodes in secondary cluster is achieved by migrating the server nodes in the secondary cluster to the idle cluster pool and migrating the service directories on the migrated server nodes back to the secondary cluster by following steps:
Step S41: obtain the static and dynamic load parameters of each server node, and weighted average the comprehensive load parameters;
Step S42: the average comprehensive load parameters of the secondary cluster are obtained by averaging the comprehensive load parameters of all the server nodes, the server nodes whose comprehensive load parameters are lower than the average comprehensive load parameters are the target server nodes, and the server nodes whose comprehensive load parameters are higher than the average comprehensive load parameters are the source server nodes;
Step S43: source server nodes are arranged in the order of comprehensive load parameters from large to small, and target server nodes are arranged in the order of comprehensive load parameters from small to large, so that source server nodes and target server nodes correspond in the corresponding order; and
Step S44: in order from large to small, the service directory in the source server node with the largest comprehensive load parameter is migrated first to the target server node with the smallest comprehensive load parameter until all server nodes achieve load balancing.

10. The method for processing data of claim 9, wherein Step S44, when migrating a service directory, determine if the size of the service directory you want to migrate is greater than the directory threshold; if the directory threshold is greater than the directory threshold, the migration directory is broken up into several sub-service directories that are less than or equal to the directory threshold, and the migration of the sub-service directories is completed in turn.
